(19) United States
(12) Patent Application Publication
(10) Pub. No.: US 2010/0107245 A1
(43) Pub. Date: Apr. 29, 2010

(54) TAMPER-TOLERANT PROGRAMS

(75) Inventors: Mariusz H. Jakubowski, Bellevue, WA (US); Chit Wei Saw, Bellevue, WA (US); Ramarathnam Venkatesan, Redmond, WA (US)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/260,581

(22) Filed: Oct. 29, 2008

(51) Int. Cl. G06F 11/00

(52) U.S. Cl. 726/22

(57) ABSTRACT

Tamper-tolerant programs enable correct and continued execution despite attacks. Programs can be transformed into tamper-tolerant versions that correct effects of tampering in response to detection thereof Tamper-tolerant programs can execute alone or in conjunction with tamper resistance/prevention mechanisms such as obfuscation and encryption/decryption, among other things. In fact, the same and/or similar mechanisms can be employed to protect tamper tolerance functionality.

### BACKGROUND

On modern computing systems, certain software requires protection against malicious tampering and unauthorized usage. For example, DRM (Digital Rights Management) systems attempt to prevent software piracy, as well as illegal distribution of music, video, and other content. Thus, developers have employed tamper-resistant software (TRS), which involves a variety of program obfuscation and hardening tactics to complicate hacker eavesdropping and tampering. While no provably secure and practical methods have been deployed, various TRS heuristics extend the time and effort required to break protection.

Among the most popular protection techniques is integrity checking or verifying that a program and its execution are tamper-free. Specific methods include computation of hashes over program code and data, along with periodic checks for mismatches between pre-computed and runtime values. Upon detection of incorrect program code or behavior, a protection system typically responds by crashing or degrading the application (e.g., via slowdown or erratic operation). Often obfuscated, this response mechanism serves to both delay hackers and deny illegitimate usage of the application.

The conventional response to tampering has caused issues with application development, including testing and debugging as well as end-user experience. For example, application bugs sometimes manifest themselves only in tamper-protected instances of applications, forcing developers to face their own (or third-party) protection measures. Bugs in the actual protection system can be especially troublesome when interacting with protected applications. Given random application failures and erratic behavior, legitimate end users may find it difficult or impractical to file bug reports and receive support. These and other problems have contributed to general unpopularity of software protection.

More specifically, since anti-tampering protection is sometimes considered irritating and unpopular, there is an unwillingness to apply such protection to best effect. Consequently, software may ship with weak security that is quickly broken by hackers while still inconveniencing legitimate users.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to tamper-tolerant programs. Such programs assume that tampering can occur with or without preventative efforts. In accordance with one aspect of the disclosure, tampering is tolerated as opposed to rendering a program unusable. Furthermore, effects of tampering can be corrected, countered, or otherwise undone. In fact, in one embodiment the program can self-correct, thereby enabling the program to continue running correctly notwithstanding attacks. Mechanisms are also provided for transforming programs into tamper-tolerant programs according to another aspect of the disclosure. Further yet, security features can be employed in an attempt to prevent tampering and/or protect tamper-tolerant technology.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a tamper-tolerant system in accordance with an aspect of the disclosed subject matter.

FIG. 2 is a block diagram of a representative correction component according to an aspect of the disclosure.

FIG. 3 is a block diagram of a tamper-tolerant program generation system according to a disclosed aspect.

FIG. 4 is a block diagram of an exemplary system for processing a program in accordance with an aspect of the disclosure.

FIG. 5 is a block diagram illustrating correction in the context of individualized modular redundancy in accordance with an aspect of the disclosed subject matter.

FIG. 6 is a block diagram of a program processing system in accordance with an aspect of the disclosed subject matter.

FIG. 7 is a flow chart diagram of a method of program modification according to a disclosed aspect.

FIG. 8 is a flow chart diagram of method of tamper-tolerant program production according to a disclosed aspect.

FIG. 9 is a flow chart diagram of a method of program modification that generates a tamper-tolerant program in accordance with one aspect of the disclosure.

FIG. 10 is a flow chart diagram of a method of tamper-tolerant program execution utilizing a randomized execution scheme according to an aspect of the disclosure.

FIG. 11 is a flow chart diagram of tamper-tolerant program execution utilizing a detection/correction scheme in accordance with an aspect of the disclosure.

FIG. 12 is a schematic block diagram illustrating a suitable operating environment for aspects of the subject disclosure.

FIG. 13 is a schematic block diagram of a sample computing environment.

### DETAILED DESCRIPTION

Systems and methods pertaining to tamper-tolerant computer programs are described in detail hereinafter. Rather than crashing, failing, or gracefully degrading in response tampering thereby rendering a program unusable or troublesome, tampering is addressed in a manner that allows a program to continue. In one instance, effects of tampering can be corrected or undone.

In accordance with one embodiment, redundancy can be employed to reduce the probability of an effective attack and/or enable switching to a tamper-free version of at least a segment of a program. Additionally, redundant techniques can be adapted to a malicious-attacker scenario by individualizing redundant portions or modules. In other words, individualized modular redundancy (IMR) can be employed to implement tamper tolerance and correction. Various applications of IMR including utilizing IMR with voting (IMR/V), detection and correction (IMR/DC), and randomized execution (IMR/RE) are described below as well as combinations of IMR with other techniques such as data encoding and shuffling, delayed responses, and checkpointing.

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

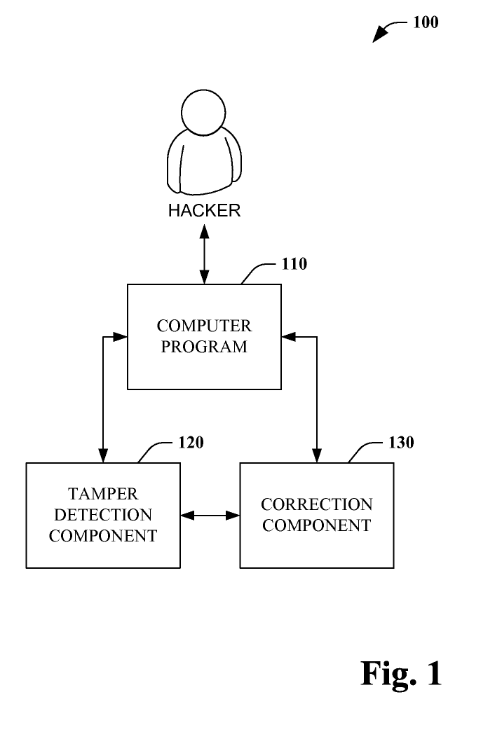

Referring initially to FIG. 1, a tamper-tolerant system 100 is illustrated in accordance with an aspect of claimed subject matter. As shown, the system 100 includes a computer program 110 (also referred to herein as simply program 110) that can correspond to software and/or be embodied in hardware (e.g., firmware). The program 110 is subject to attacks, malicious or otherwise, by a hacker. The goal of the hacker is to tamper with the program for one reason or another. For example, a hacker might seek to alter the program 110 to circumvent access control in the form of digital rights management (DRM) technologies to allow the program 110 or associated data to be used in a restricted manner.

Tamper detection component 120 monitors and/or analyzes the program 110 in an attempt to identify tampering, meddling, interfering or the like with program operation. In other words, integrity checks or the like can be performed to verify the existence of tampering or lack thereof. Various known or novel techniques can be employed by the tamper detection component 110. For instance, a current program pattern or shape can be compared to an original program pattern to detect modifications before and/or during program execution. Additionally or alternatively, checksums of byte code or oblivious hashing of execution traces can be employed to verify proper execution or detect tampering.

Conventional tamper resistant or anti-tampering systems respond to tamper detection by producing a crash, gradual failure, or degradation of services rendering the program unusable or at least troublesome. Tamper resistant systems seek to prevent modification of software against an author or vendor's wishes. Where tampering is detected, it is desirous to prevent further modification, observation, and/or reverse engineering by complicating attacks via crash, failure, or degradation, among other things. While this is effective with respect to its goals, tamper resistant systems are irritating to legitimate end users and developers where bugs or other issues invoke such mechanisms. This discourages employment of such systems and/or utilization of weak security easily broken by hackers.

System 100 provides a mechanism to effect tamper tolerance. Here, the response to tamper detection is different. More specifically, correction component 130 is a mechanism for correcting, undoing, or countering undesired modifications to a program. Alterations to the program 110 by a hacker or the like are initially tolerated and subsequently rendered ineffective via the combination of tamper detection component 120 and correction component 130. For example, upon identification of tampering with a variable by detection component 120, correction component 130 can update the variable with the correct value. As will be described further infra, the detection component 120 and the correction component 130 can be injected within the program 110 in accordance with one embodiment creating a tamper-tolerate program that employs self-correction.

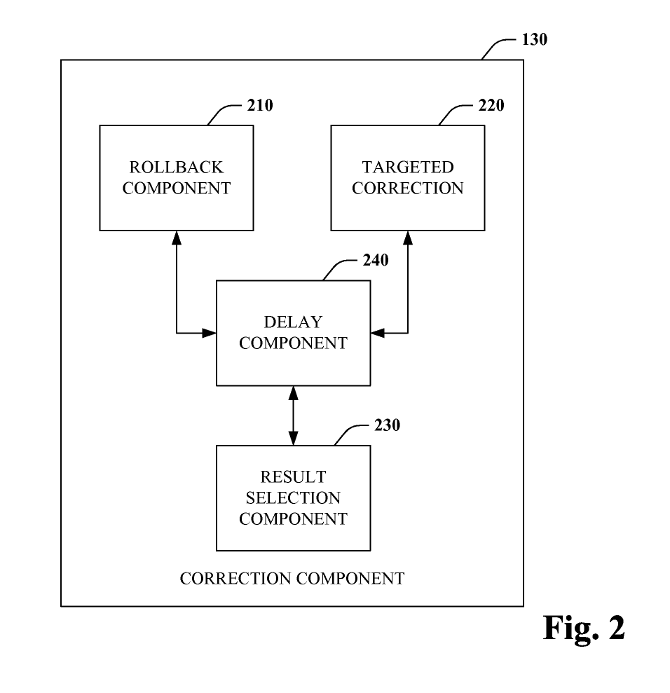

FIG. 2 depicts a representative correction component 130 in accordance with an aspect of the claimed subject matter. Again, the correction component 130 ensures that tamper-free code is executed with respect to a program, for example by executing a tamper-correction transform/transformation. As illustrated, the correction component 130 can include a rollback component 210 that returns a program to a state prior to tampering thus removing effects of tampering. Checkpoints, or summaries of program state sufficient to restart execution, are saved periodically for purposes of rolling back. For example, where an attack alters program state without patching code such that canceling or redoing operations cannot effectively fix the tampering, rollback can be utilized return to some arbitrary point prior to the attack. In one instance, the rollback component 210 can leverage existing checkpoint technology such as that associated with debuggers, virtual machines, and simulators, amongst others.

Additionally or alternatively, the correction component 130 can employ targeted correction component 220. As the name suggests, where a particular alteration is detected the change can simply be fixed or undone in a targeted manner, rather than rolling all state back to a previous point, for instance. In one embodiment, upon identification of a particular modification the targeted correction component 130 can simply cancel or remove an attacker-injected operation and/or copy over a segment of code and re-execute. In another embodiment, the correction component 130 can reason about detected tampering and potential responses. Based on an identified program alteration, the correction component 130 can determine or infer the best approach for modifying the program to eliminate the change.

The correction component 130 can also employ a specific type of correction via the result-selection component 230. The result-selection component 230 is a mechanism for identifying a final result that is employed by a program. As will be described further in later sections, redundancy can be employed as a mechanism to facilitate correct program operation. In particular, a program can be divided into distinct, independent function units, which can then be replicated many times. The result-selection component 230 identifies one final result for use by the program for a particular functional unit amongst a plurality of results afforded by copies. Various embodiments exist for selecting a specific result including selecting the most common result amongst the copies, determining or inferring correctness of a copy and selecting results associated with a correct copy, identifying and correcting for errors,among other things. It is noted that the result selection component 230 could be a form of targeted correction. However, it is depicted separately to emphasize and facilitate discussion of this particular embodiment.

The correction component 130 additionally includes a delay component 240 that postpones correction by one or more mechanisms. In accordance with one aspect of the claimed subject matter, tamper detection and correction can be separated in time and space. Among other things, this prevents identification of tolerance system operation, mainly by disguising and hiding corrective response mechanisms. Delay component 240 defers correction application from the point at which it is possible to another point to frustrate hacking efforts. If correction is performed as soon as possible or very quickly, a hacker may notice that something is wrong and his alteration is not having the intended effect. Delay component 240 addresses this by waiting a few seconds, minutes, hours, days, etc. prior to allowing a program to be fixed. That separates detection from the response and makes it difficult for a hacker to trace back to where the tampering was detected.

Of course, delay component 240 can be optional. Alternatively, delay component 240 can be implemented for invocation in certain scenarios or blocked from employment in others. Furthermore, the actual delay time can be specific to particular tampering and/or derived as a function of a cost/benefit analysis, wherein cost refers to potential damaging impact of allowing an alteration to remain and benefit pertains to hacker frustration. For example, where a digital music program is tampered with in a manner that allows free music downloads, there will likely be little, if any, delay to protect copyrights of music owners, as losses would increase exponentially over time.

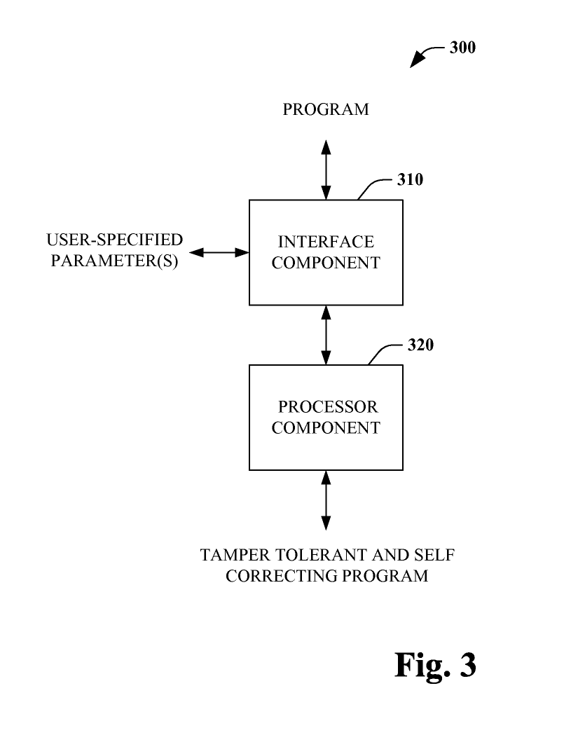

Referring to FIG. 3, a tamper-tolerant-program generation system 300 is illustrated in accordance with an aspect of the claimed subject matter. Interface component 310 is a mechanism for receiving, retrieving or otherwise acquiring a program and optionally user specified parameters. The program can be any hardware/software program associated with a processor-based device such as a computer. Further, the program can be in any form such as high-level source code or lower level byte code, amongst others. The user-specified parameters can influence if and how a tamper-tolerant mechanism is employed with respect to the program. Upon acquisition of a program and optionally user parameters, such information can be made available to processor component 320, which transforms the program into a tamper-tolerate program in accordance with the parameters or a default configuration. In furtherance thereof, various code can be injected or embedded within the program and/or the program can be reorganized or rewritten in an equivalent form. Specifically, the program can be modified in such a manner that it tolerates tampering and subsequent to identification corrects or undoes the effects of tampering.

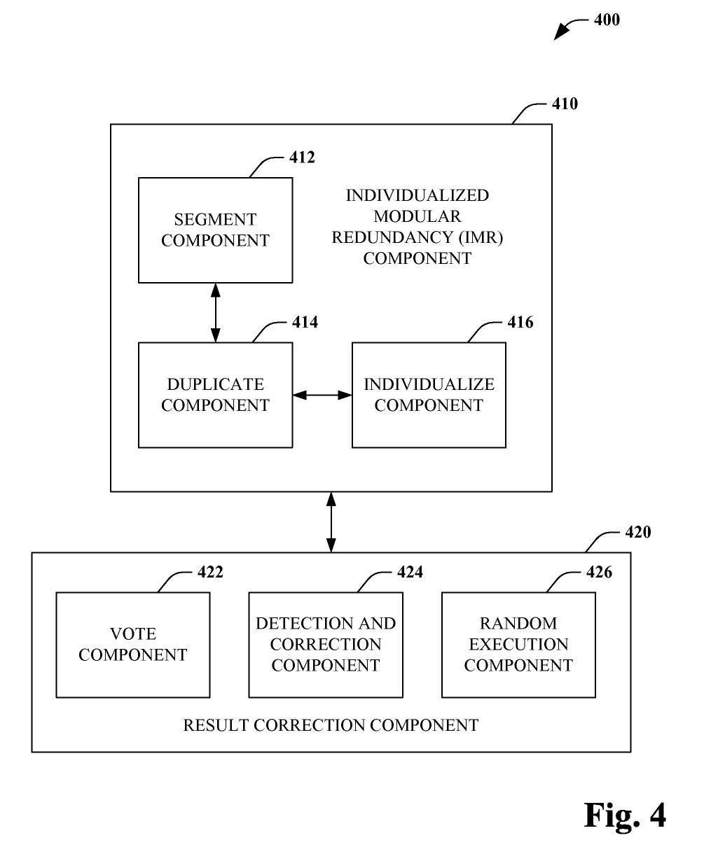

FIG. 4 depicts a system 400 for processing a program in accordance with an aspect of the claimed subject matter. The system 400 includes an individualized modular redundancy (IMR) component 410 and a result correction component 420. The IMR component 410 includes a segment component 412 that divides a program into distinct, independently functioning units or blocks. For each of these blocks duplicate component 414 generates a number of replicas or copies of the blocks. The exact number can be dictated by user parameters, a default configuration, or an intelligently selected or inferred number. For example, if it can be determined that it is likely that a program or segment of the program will be tampered with then a greater number of copies will be generated, whereas if the program or segment of the program is not likely to be tampered with then the number of copies can be reduced to improve program performance. Each copy can be individualized by the individualize component 416. In other words, the same code can be made appear different without affecting functionality. Among other things, this will force adversaries to duplicate analysis efforts.

In essence, IMR component 410 duplicates code blocks at various granularities (e.g., basic blocks, entire functions . . . ), wherein the copies are diversified yet functionally equivalent. These code blocks can be treated as deterministic functions that map input to outputs without side effects. At runtime, the different copies can execute at various times or in parallel, producing individual intermediate output, which should be the same if no tampering occurs.

Parallelism for redundant execution can be implemented by multiple software or hardware threads or processes; multiple cores or processors; multiple redundant systems; or any other means of concurrent execution. This includes taking advantage of potentially unused redundant computing resources, resulting in tamper-tolerant computation that incurs little or no performance impact.

Result correction component 420 outputs a final result from amongst a plurality of intermediate results computed by copies or duplicates afforded by IMR component 410. The final result is selected from intermediate results that may or may not have been subject to tampering. In one sense, the component 420 operates to correct or ensure output of correct results despite tampering. However, correctness can also be defined in terms of a probability in accordance with one embodiment. As shown, the result correction component 420 includes a vote component 422, detection and correction component 424 and random execution component 426.

The vote component 422 executes a tamper-correction transform selects a final result from intermediate results as a function of a voting mechanism wherein the results represent votes and the majority wins. Given no tampering, the vote will be unanimous. That is, all redundant copies generate the same output. Where tampering is present with respect to one or more copies, different results are output by the copies. Here, the most common intermediate output is subsequently selected by the vote component 422 as the final result. In other words, correction is performed via majority vote. This is likely to result in a correct final result despite tampering, since it is unlikely that tampering would be effected on a majority of the redundant copies.

The detection and correction component 424 resorts to redundant execution upon detection of tampering. The component 424 checks execution of code blocks for correctness, for example by way of verifying code-byte checksums or oblivious hashes of execution, for instance. Upon detection of tampering, a redundant version of the code block can be selected as well as executed and again runtime integrity of the code block verified. The detection and correction component 424 can call another individualized version of the block or overwrite the tampered code with new code from a repository of possible redundant blocks, among other things. Detection and correction can repeat until a copy of the block executes successfully without tampering or until no more blocks are available. As will be described further infra, other correction mechanisms can be employed to handle side effects of detection and correction, if they exist.

The random execution component 426 selects a redundant and/or individualized block randomly or pseudo-randomly for execution providing probabilistic correction or assurances. For example, given three redundant functionally equivalent code blocks “A,” “B,” and “C,” the random execution component 426 chooses and executes one with some probability, namely one-third for each of “A,” “B,” and “C.” If an attacker tampers with only “A,” execution will still be correct with probability two-thirds, since “B” and “C” may be selected. Controlled by opaque predicates and/or obfuscation mechanisms, among other things, block selection can vary during runtime and/or between runs of a program.

It is to be appreciated that result correction component 420 can include subcomponents or embodiments as shown, among others. Furthermore, combinations of functionality or hybrids can also be employed. For example, a random execution implementation can be converted to a voting implementation by randomly selecting a tampered copy a predetermined number of times. Specifics can be controlled manually by way of user specified parameters and/or automatically as a function of contextual information.

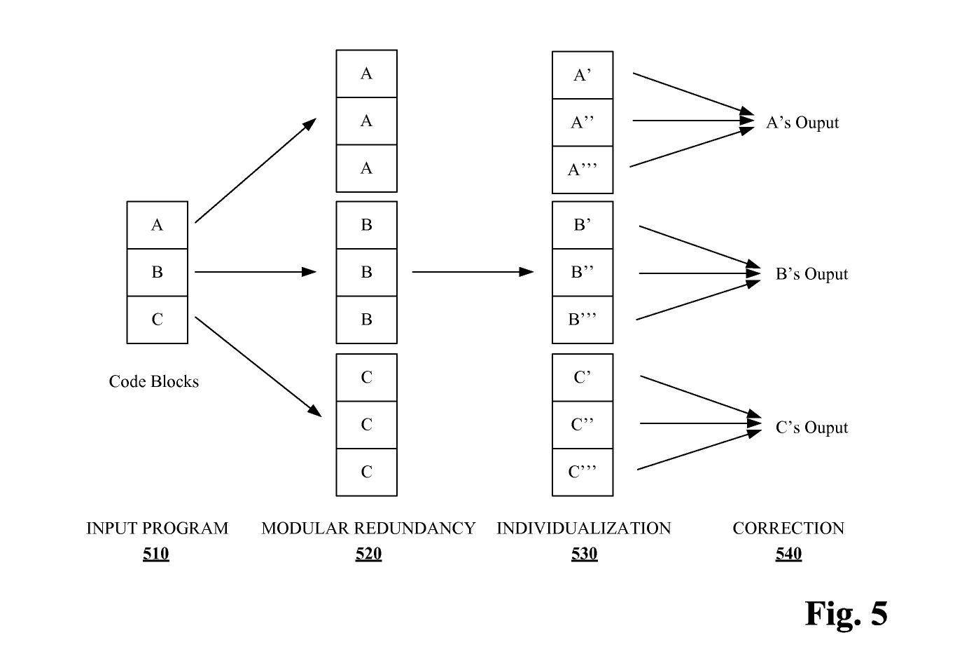

FIG. 5 illustrates correction in the context of individualized modular redundancy in accordance with an aspect of the claimed subject matter. As depicted, an input program 510 can be received, retrieved, or otherwise obtained or acquired. The input program 510 can then be divided into independently functioning units or code blocks “A,” “B,” and “C.” These code blocks can then be replicated numerous times in accordance with some manual or automatically determined parameter, for example. This is referred to as modular redundancy 510, and as shown, each of code blocks “A,” “B,” and “C” include three replicates. Of course, each code block can be replicated a different number of times. Here, however, they are each replicated three times for solely for clarity and ease of understanding. Each code block replicate or copy is individualized as shown at 530, wherein each copy is altered to appear different to adversaries without affecting functionality. From the individualized copies, a final result or output can be selected or computed from a plurality of intermediate results afforded by the copies at 540 in accordance with a particular tamper-correction transform, strategy, or scheme.

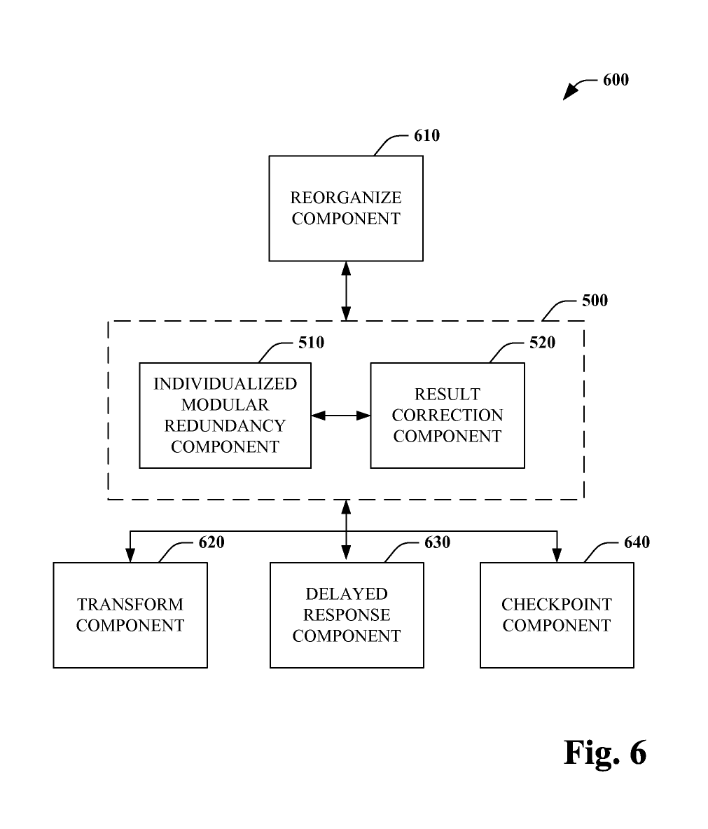

FIG. 6 illustrates a program processing system 600 in accordance with an aspect of the claimed subject matter. The system 600 provides a mechanism for program transformation to facilitate tamper tolerance and/or self-correction, among other things. The system 600 includes system 500 as previously described with respect to FIG. 5 including the IMR component 510 and result correction component 520. The system 600 also includes several components that supplement functionality performed by system 500 including reorganize component 610, transform component 620, delayed response component 630 and checkpoint component 650. Three components pertain to discouraging or complicating an attack, namely reorganize component 610, transform component 620 and delayed response component 630, while the checkpoint component 630 provides a recovery mechanism.

The reorganize component 610 facilitates reorganization, rearranging or shuffling of code within a program to prevent analysis, tracking, and ultimately malicious hacking of a program. Often times, hackers will employ one or more data flow analysis tools to glean information about how a program operates. Shuffling data and/or code statically and/or dynamical frustrates this objective. By way of example and not limitation, variables can be continually or periodically moved in memory to prevent easy data flow analysis and tracking. Additionally or alternatively, code blocks can be relocated including separating redundant blocks.

The transformation component 620 transforms data and/or code into a different form thereby making it difficult to comprehend. Although not limited thereto, the transformation can correspond to encryption, scrambling, or the like. For instance, a transform can be employed to provide more secure result correction. Consider the context of individualized modular redundancy, for instance. In this scenario, intermediate results produced by multiple copies can be encrypted. When results are to be analyzed in accordance with a voting scheme, for example, result values can be decrypted at that time. While transformation such as encryption/decryption, scrambling/unscrambling or the like can be performed explicitly as an additional operation, it is to be noted that it can also be coalesced into operations and performed implicitly.

Correction of tampering can be postponed by the delayed response component 630. Tamper detection and correction can be separated in time as well as space. Among other things, this prevents easy identification of tamper detection and correction by disguising and/or hiding the corrective response mechanism. In other words, rather than immediately applying a corrective action in response to detection of tampering, the delayed component 630 facilitates postponing of correction in accordance with a user parameter or automatically as a function of context. For instance, whether or not delay is employed and the extent thereof can be determined or inferred as a function of known or acquirable context information such as potential for harm, current and/or future process load, previously employed delays, and/or security mechanisms employed, among other things.

The checkpoint component 640 facilitates employment of checkpoint or rollback functionality in context of tamper tolerance and self-correction. The checkpoint component 640 can implement such functionality and/or leverage existing and available checkpoint technology. Upon tamper detection, execution can be rolled back to an earlier point/state prior to tampering. Checkpoints are summaries of program state sufficient to restart execution and can be saved periodically or upon request for this purpose. Among other things, attacks that alter program state without patching code can be countered by way of rollback to fix tampering. Furthermore, checkpointing can be employed with respect to IMR detection and correction to provide a correct program state and inputs before a block of redundant code executes. Similarly, checkpoint functionality can be employed in conjunction with a randomized execution scheme to rollback to an earlier point and undo tampering where tampering beats the odds and succeeds.

The aforementioned systems, architectures, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems above and methods below can include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, the correction component 130 can employ such mechanism to infer appropriate and/or optimal correction and delay, among other things. In other words, the correction component 130 can enable intelligent self-correction in response to tampering.

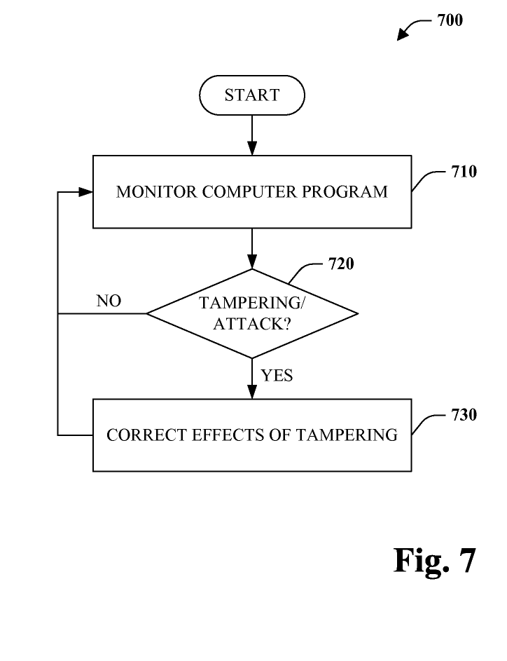

In view of the exemplary systems described supra, methodologies that may be implemented in accordance with the disclosed subject matter will be better appreciated with reference to the flow charts of FIGS. 7-1 1. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Referring to FIG. 7, a method of tamper-tolerant computing 700 is illustrated in accordance with an aspect of the claimed subject matter. At reference numeral 710, a computer program is monitored during execution. A determination is made as to whether tampering or an attack has been detected during monitoring or not at numeral 720. If no tampering is detected (“NO”), the method 700 loops back to 710. If tampering is detected (“YES”), the effects are corrected at reference numeral 730. Correction can be targeted to update altered code and/or remove injected code or more general such as in a rollback where program state is returned to a point prior to tampering and execution begins there. In accordance with one aspect of the claimed subject matter, the program can self-correct. However, one or more services external to the program can also be employed.

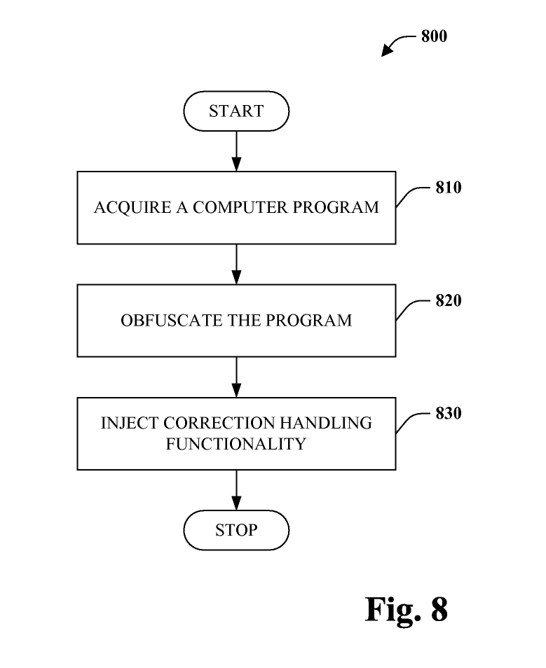

FIG. 8 is a flow chart diagram of a method of computer program modification 800 in accordance with an aspect of the claimed subject matter. At reference numeral 810, a computer program is acquired or otherwise identified. At numeral 820, at least a portion of the program is obfuscated or otherwise transformed, for example utilizing a hash function or encryption scheme. This provides a degree of protection against program and/or tolerance mechanism tampering. The goal can be to prevent, deter, or at least not make tampering easy. At reference numeral 830, correction-handling functionality is injected into the program that reverses or undoes tampering and/or effects thereof. In one embodiment, this can involve injection of implementation of individualized redundancy schemes. Of course, the claimed subject matter is not limited thereto. Other embodiments are possible and contemplated that capture such correction functionality including without limitation checkpointing/rollback.

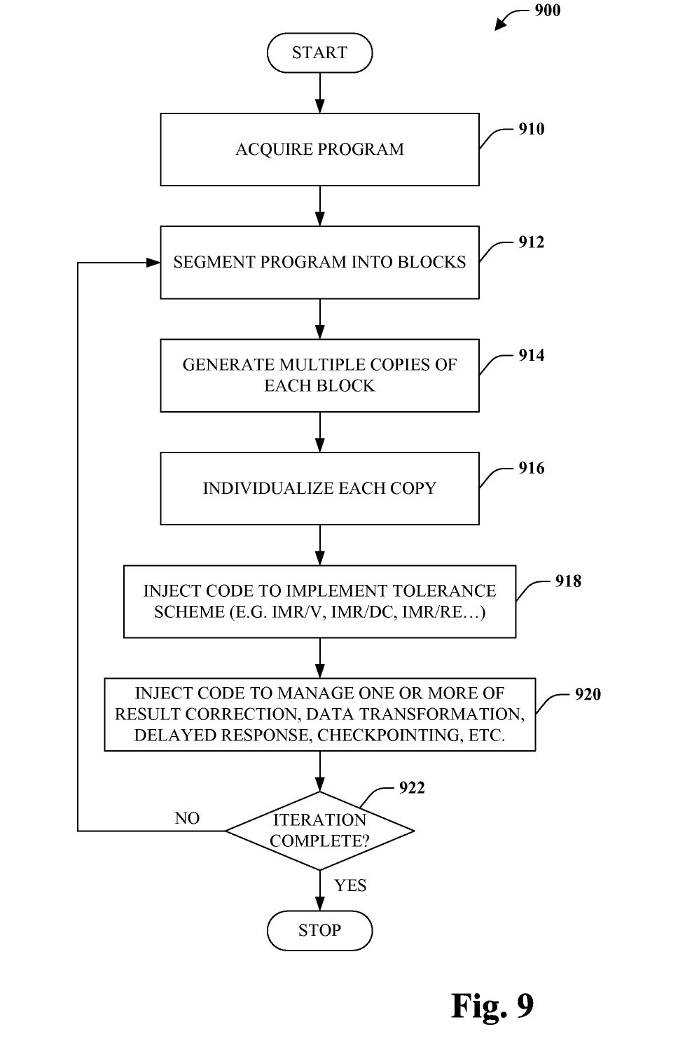

FIG. 9 illustrates a method 900 of modifying a program to implement tamper tolerance in accordance with an aspect of the claimed subject matter. At reference numeral 910, a program is acquired or otherwise identified. The program is segmented into distinct, independent units or blocks at numeral 912. Multiple copies of each block are generated at reference 914 providing redundancy and a foundation for implementation of failover or switching where one block is not operating correctly. Each copy is individualized at reference 916 wherein alterations are made to make it appear different while retaining functional equivalency. Like other functionality, individualization can be performed statically during program modification and/or the functionality can be inserted for dynamic or runtime execution. Furthermore, iteration can be controlled by user-specified parameters and/or managed automatically by the protection tool. At numeral 918, code is injected to implement a tolerance scheme (e.g. IMR/V, IMR/DC, IMR/RE . . . ). At reference numeral 920, code is injected to manage one or more of result correction, data transformation, delayed response, and/or checkpointing, among other things. At reference 922, a determination is made as to whether iteration is complete. It should be appreciated that for enhanced security, one or more of the previous actions can be can be performed two or more times so that tamper-tamper tolerance measures are protected by one or more layers of tamper tolerance. Actions can continue to be performed until iteration is complete at which time the method 900 terminates.

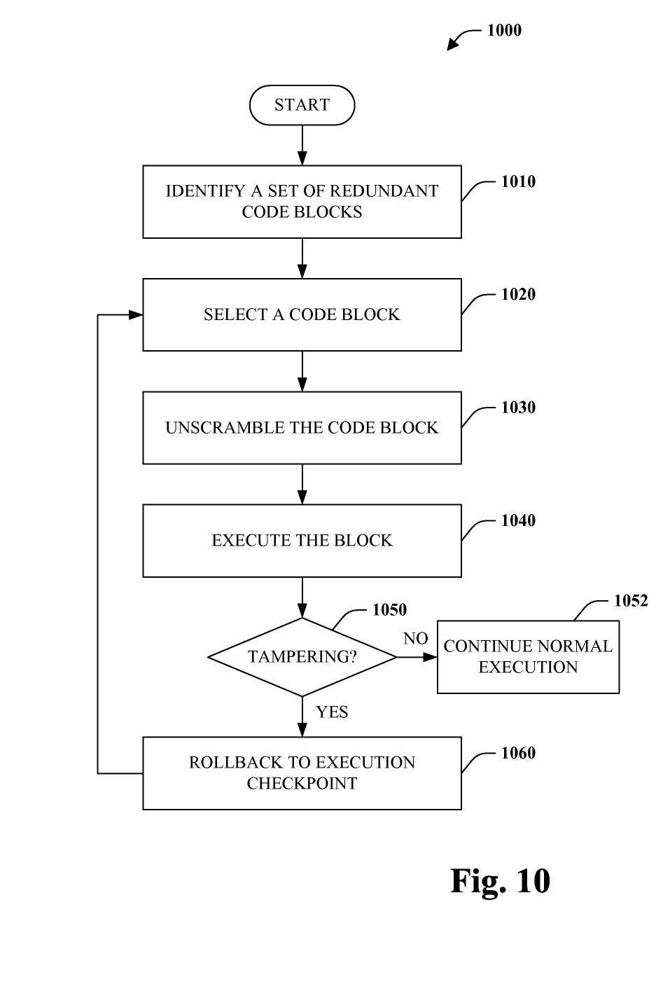

FIG. 10 is a method 1000 of tamper-tolerant program execution utilizing a randomized execution scheme in accordance with an aspect of the claimed subject matter. At reference numeral 1010, a set of redundant and potentially individualized code blocks is identified. These blocks represent functionally equivalent copies of code desired to be executed. At numeral 1020, a code block from amongst the set is selected at random or pseudo-randomly. Block selection can vary during runtime and/or between runs of a program, among other things. The code block is unscrambled, decrypted or otherwise transformed where necessary at 1030. At reference 1040, the code block is executed. At this point the probability that tampering has occurred with respect to the executed block is dependent upon the number of redundant copies. In any event, there is a possibility that the selected block has been altered. Where tampering is detected at reference 1050, the method continues at numeral 1060 where execution is rolled back to a checkpoint prior to execution of an incorrect block. The method can then proceed to 1020 where a new block is selected for execution. The method continues until a block executes that has not been altered as determined at reference numeral 1050. In this case, the execution continues as normal as reference numeral 1052.

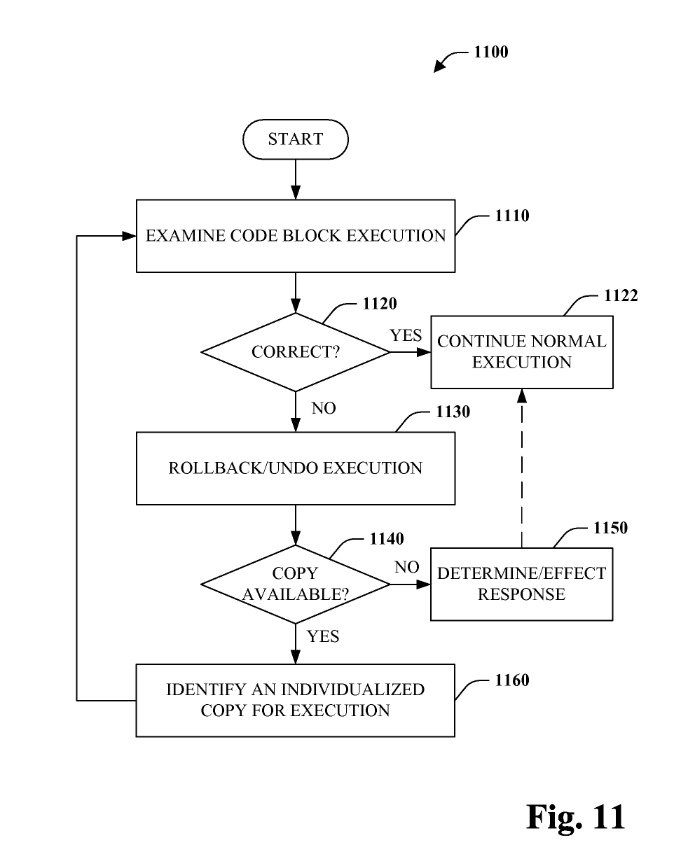

FIG. 11 depicts a method 1100 of tamper-tolerant program execution utilizing a detection/correct scheme in accordance with an aspect of the claimed subject matter. At reference numeral 11 10, code block execution is examined with respect to code integrity. If the code executes correctly without tampering as determined at numeral 1120 (“YES”), execution can continue as normal at 1122. Alternatively, if tampering is detected at numeral 1120 (“NO”) the method continues at reference 1130. Standard or novel techniques can be utilized to determine correct or incorrect execution including without limitation verification of code-byte checksums and/or oblivious hashes of execution. At reference 1130, a rollback or undo operation is performed to undo execution of the incorrect code. At numeral 1140, a determination is made as to whether a redundant copy of the code block is available. If a copy is not available (“NO”), a response is determined and executed at 1150. For example, a message may or may not be produced indicating failure caused by tampering and program execution terminated. In other instances, the program can crash or otherwise degrade performance, but allow program execution to continue. If a copy is available (“YES”), the method continues at numeral 1160 where a copy is identified for execution. The method subsequently proceeds back to reference numeral 1110 where execution of the copy code block is examined.

It is to be appreciated that concepts associated with other computing technologies issues can be extended and adapted for employment with respect to tamper tolerance and/or correction. For example, fault tolerance is a rich area that has seen much theoretical and practical work, but aims mainly to defend against “random” or unintentional failures, not against intelligent malicious attackers. Nonetheless, concepts of fault tolerance namely redundancy and failover are also applicable to tamper tolerance and correction. Similarly, error-correction methods are geared toward addressing noisy data transmissions but are useful as well. Accordingly, in one instance tamper tolerance and correction can be viewed as an adaptation and extension of fault tolerance and error correction to an intelligent-attacker scenario in program protection.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated that a myriad of additional or alternate examples of varying scope could have been presented, but have been omitted for purposes of brevity.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic - that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject innovation.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

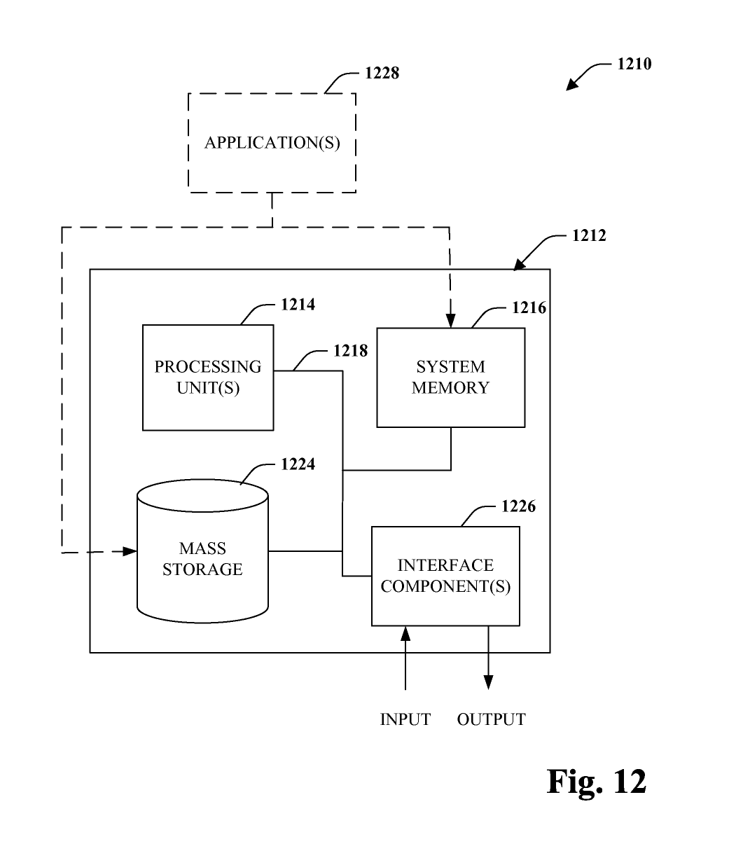

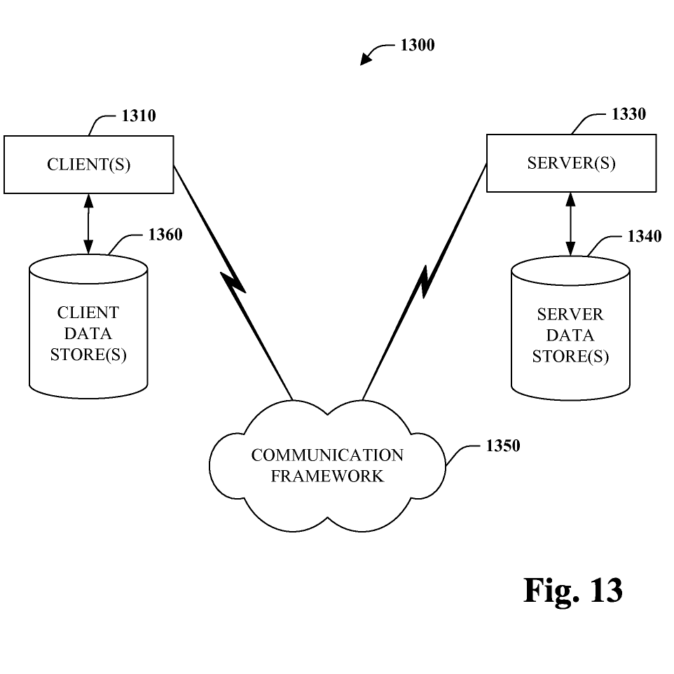

In order to provide a context for the various aspects of the disclosed subject matter, FIGS. 12 and 13 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 12, an exemplary environment 1210 for implementing various aspects disclosed herein includes a computer 1212 (e.g., desktop, laptop, server, hand held, programmable consumer or industrial electronics . . . ). The computer 1212 includes a processing unit 1214, a system memory 1216, and a system bus 1218. The system bus 1218 couples system components including, but not limited to, the system memory 1216 to the processing unit 1214. The processing unit 1214 can be any of various available microprocessors. It is to be appreciated that dual microprocessors, multi-core and other multiprocessor architectures can be employed as the processing unit 1214.

The system memory 1216 includes volatile and nonvolatile memory. The basic input/output system (BIOS), containing the basic routines to transfer information between elements within the computer 1212, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 1212 also includes removable/non-removable, volatile/non-volatile computer storage media. FIG. 12 illustrates, for example, mass storage 1224. Mass storage 1224 includes, but is not limited to, devices like a magnetic or optical disk drive, floppy disk drive, flash memory, or memory stick. In addition, mass storage 1224 can include storage media separately or in combination with other storage media.

FIG. 12 provides software application(s) 1228 that act as an intermediary between users and/or other computers and the basic computer resources described in suitable operating environment 1210. Such software application(s) 1228 include one or both of system and application software. System software can include an operating system, which can be stored on mass storage 1224, that acts to control and allocate resources of the computer system 1212. Application software takes advantage of the management of resources by system software through program modules and data stored on either or both of system memory 1216 and mass storage 1224.

The computer 1212 also includes one or more interface components 1226 that are communicatively coupled to the bus 1218 and facilitate interaction with the computer 1212. By way of example, the interface component 1226 can be a port (e.g., serial, parallel, PCMCIA, USB, FireWire . . . ) or an interface card (e.g., sound, video, network . . . ) or the like. The interface component 1226 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer, and the like. Output can also be supplied by the computer 1212 to output device(s) via interface component 1226. Output devices can include displays (e.g. CRT, LCD, plasma . . . ), speakers, printers, and other computers, among other things.

FIG. 13 is a schematic block diagram of a sample-computing environment 1300 with which the subject innovation can interact. The system 1300 includes one or more client(s) 1310. The client(s) 1310 can be hardware and/or software (e.g., threads, processes, computing devices). The system 1300 also includes one or more server(s) 1330. Thus, system 1300 can correspond to a two-tier client server model or a multi-tier model (e.g., client, middle tier server, data server), amongst other models. The server(s) 1330 can also be hardware and/or software (e.g., threads, processes, computing devices). The servers 1330 can house threads to perform transformations by employing the aspects of the subject innovation, for example. One possible communication between a client 1310 and a server 1330 may be in the form of a data packet transmitted between two or more computer processes.

The system 1300 includes a communication framework 1350 that can be employed to facilitate communications between the client(s) 1310 and the server(s) 1330. The client(s) 1310 are operatively connected to one or more client data store(s) 1360 that can be employed to store information local to the client(s) 1310. Similarly, the server(s) 1330 are operatively connected to one or more server data store(s) 1340 that can be employed to store information local to the servers 1330.

Client/server interactions can be utilized with respect to various aspects of the claimed subject matter. By way of example and not limitation, one or more components can be embodied as network or web services, wherein one or more clients 1310 request and acquire functionality from one or more servers 1330 across the communication framework 1350. For instance, the interface component 310 and process component 320 of FIG. 3 can form part of a network service that acquires a program and transforms the program into a tamper-tolerant program in accordance with one or more aspects of the claims. Further yet, correction component 130 of FIG. 1 can be embodied as a web service which that upon detection of a tampering the service can be contacted to correct and/or identify a correction to remove the effects of tampering.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims. Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

What is claimed is:

1. A tamper-tolerant system, comprising:
a tamper detection component that monitors a computer program and identifies an unauthorized alteration of the program; and
a correction component that automatically undoes the alteration to correct the program and allow continued execution in the presence of tampering.

2. The system of claim 1, the correction component delays operation to prevent easy identification of a corrective response.

3. The system of claim 1, the correction component rolls back execution to an earlier point in time captured by a checkpoint to remove the unauthorized alteration.

4. The system of claim 1, the computer program is obfuscated to inhibit program analysis and tampering.

5. The system of claim 4, program data is encoded and/or shuffled to prevent data flow analysis.

6. The system of claim 1, further comprising replicated and individualized program code blocks of equivalent functionality to facilitate correct program execution.

7. The system of claim 6, the correction component employs a tamper-correcting transform that selects as a final output the most common result from the code blocks given the same input.

8. The system of claim 6, the correction component employs a tamper-correcting transform that computes a final output from encrypted results produced by the code blocks given the same input.

9. A method of program execution in the presence of program tampering, comprising:
executing a number of individualized and redundant copies associated with a code block; and
selecting results produced by a copy as output for the code block to avoid undesired results caused by tampering, while continuing execution.

10. The method of claim 9, comprising selecting the results that match a majority of results amongst copy results.

11. The method of claim 9, comprising selecting the results from a copy subsequent to tamper detection.

12. The method of claim 11, further comprising:
analyzing copy integrity; and
selecting a different copy iteratively until an untampered copy is selected or all copies have been selected.

13. The method of claim 9, comprising:
randomly selecting a copy and produced results; and
rolling back to a prior execution state and selecting a different copy and results produced thereby where tampering is detected

14. A method of producing a tamper-tolerant computer program, comprising:
segmenting a computer program into a plurality of code blocks;
generating a plurality of replicates of each code block;
individualizing each replicate while maintaining functional equivalence; and
employing the replicates to produce correct output despite tampering with at least one replicate.

15. The method of claim 14, further comprising injecting code to select a replicate as output for a code block as a function of the most common result produced amongst the replicates.

16. The method of claim 14, further comprising introducing code into the program that upon detecting tampering with respect to a code block executes a replicate.

17. The method of claim 16, the introduced code analyzes correctness of the replicate and calls another replicate where tampering is detected until a replicate is identified that produces correct results.

18. The method of claim 14, further comprising injecting functionality that removes side effects introduced by tampered block execution.

19. The method of claim 14, further comprising injecting encryption and decryption functionality with respect to program code and/or data.

20. The method of claim 14, further comprising introducing data shuffling functionality that moves data in memory to prevent easy data flow analysis and tracking.
